(19) United States
(12) Patent Application Publication
(10) Pub. No.: US 2009/0176540 A1
(43) Pub. Date: Jul. 9, 2009

(54) AUDIO SELECTION CONTROL FOR PERSONAL COMMUNICATION DEVICES

(75) Inventors: Lydia Mai Do, Research Triangle Park, NC (US); Travis M. Grigsby, Austin, TX (US); Pamela Ann Nesbitt, Tampa, FL (US); Lisa Anne Seacat, San Francisco, CA (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 11/970,036

(22) Filed: Jan. 7, 2008

(51) Int. Cl. H04M 1/02; G08B 3/00

(52) U.S. Cl. 455/575.2; 340/384.7

(57) ABSTRACT

The distribution of audio signals to either a headset or to a base unit (such as a cell phone) is determined by whether the headset is ready for use when a call is made or received. The headset is considered ready for use if it is powered on, has been initialized to exchange signals with the base unit using a standard communications protocol (such as Bluetooth), and is in place on the user's head. The headset includes a proximity sensor that provides a signal indicating that the headset is in place. If the headset is ready for use, audio signals are automatically distributed to the headset. Otherwise, the audio signals were distributed to a cell phone audio system. The invention may also be used by a personal computer user having an audio headset.

### BACKGROUND OF THE INVENTION

The present invention relates to personal communication devices and more particularly to an audio selection control system that makes it easier to use such devices.

The widespread availability and extensive use of cell phones (and related devices such as communication-enabled Personal Digital Assistants or PDA's) have become facts of life. Such devices make it possible for users to communicate with others at almost any time and in almost any place either for personal or business reasons.

A significant number of cell phone users now use wireless headsets that enable them to use their cell phones without even having to hold the cell phone. Wireless headsets are becoming popular because they can make it easier and safer to use cell phones in certain environments.

Before a particular wireless headset can be used with a particular cell phone, the wireless headset and cell phone must be identified to each other in a linking or pairing process. Once the pairing process is complete, the wireless headset and cell phone can communicate with each other using a standard communications protocol, such as the well-known Bluetooth protocol.

It is generally expected that a user who has gone to the trouble of pairing a wireless headset to a cell phone intends to continue using that wireless headset until either the cell phone or the wireless headset is manually powered down. The headset audio components (speaker and microphone) will remain enabled while the cell phone audio components (speaker and microphone) will remain disabled until either the wireless headset or the cell phone is manually powered down to break the communications link between the two and “reset” the cell phone for conventional hands-on operation.

When a cell phone user has repeated the actions required to set up and use a wireless headset a few times, the actions become second nature and the user basically stops consciously thinking about the headset. An unfortunate consequence of this is that the user may forget that the wireless headset has already been set up. It is not uncommon for a cell phone user to pick up a ringing cell phone, try to answer it and then eventually realize the audio signals are being directed to a wireless headset that the cell phone user previously removed and set aside someplace. This can lead to a mad scramble to find the wireless headset, put it on and answer the call using the wireless headset controls before the caller abandons the call attempt. Naturally, both the calling party and the called party may become frustrated when this happens.

### BRIEF SUMMARY OF THE INVENTION

The present invention may be embodied as a method for controlling the distribution of audio signals among audio systems in a headset and in a base unit. A determination is made whether the headset is ready for use. If the headset is ready for use, audio signals are distributed to the headset audio system. If it can't be determined that the headset is ready for use, a determination is made whether a base unit audio system is ready for use. If the base unit audio system is ready for use, the audio signals are distributed to the base unit audio system.

The present invention may also be embodied as an audio control system for controlling the distribution of audio signals among audio systems in a headset and in a base unit. The audio control system includes communications control logic for receiving signals from an audio headset and for determining whether the received signals indicate the audio headset is ready for use by a user of the base unit. The audio control system also includes audio control logic that responds to a determination that the headset is ready for use by distributing audio signals to the audio headset. The audio control logic responds, in the absence of a determination that the audio headset is ready for use, to distribute audio signals to the base unit audio system.

The present invention may also be embodied as a computer program product for controlling the distribution of audio signals among audio systems in a headset and in a base unit. The computer program product includes a computer usable medium embodying computer usable program code including computer usable program code configured to determine whether the headset is ready for use and to distribute audio signals to the headset in response to a determination that the headset is ready for use. The computer program product further includes computer usable program code configured, in the absence of a determination that the headset is ready for use, to determine whether a base unit audio system is ready for use and to distribute audio signals to the base unit audio system when it is determined that the base unit audio system is ready for use.

### BRIEF DESCRIPTION OF THE SEVERAL VIEWS OF THE DRAWINGS

FIG. 1 is a pictorial representation of a Bluetooth headset and a cell phone that represent a principal environment in which the present invention may be implemented.

FIG. 2 is a pictorial representation showing a different surface of the same Bluetooth headset.

FIG. 3 is a block diagram of major functional components that would be included in a headset implementing the present invention.

FIG. 4 is a block diagram of major functional components that would be included in a cell phone implementing the present invention.

FIG. 5 is a flow chart of operations that would be performed in a cell phone implementing the present invention each time a call is received.

FIG. 6 is a pictorial illustration of a different environment in which the present invention may be implemented.

FIG. 7 is a block diagram of the major functional components of a general-purpose programmable computer device in which the present invention could be implemented in the environment illustrated in FIG. 6.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

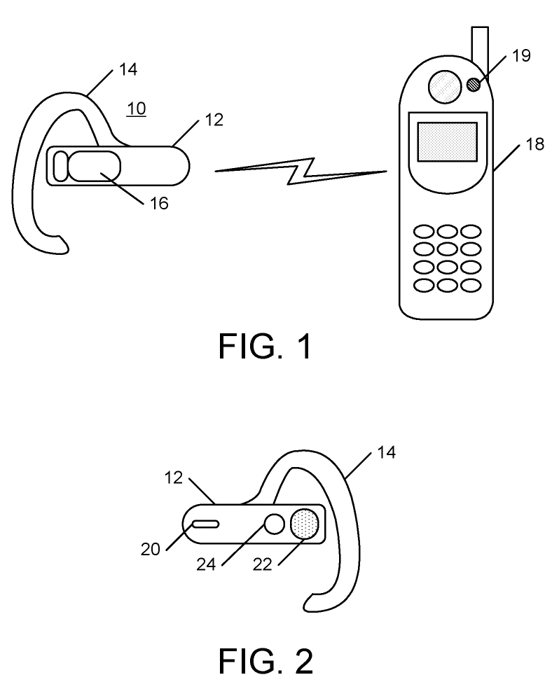

FIG. 1 is a pictorial illustration of a cellular telephone or cell phone 18 and one form of a wireless headset 10 that can be employed to allow a user to operate the cell phone 18 in a hands-free mode. The headset 10 includes a retainer 14 that the user slips over one ear to keep the headset in place during use and a body 12 that includes one or more control buttons 16 that can be used to initiate or terminate telephone calls and/or to control the volume of audio signals delivered to a speaker in the headset 10.

FIG. 2 is a pictorial illustration of the opposite surface of the headset 10 showing the headset speaker 22 and the headset microphone 20. The headset, as described thus far, is conventional in nature. However, unlike a conventional headset, headset 10 also includes a proximity sensor 24 that can be characterized as a “readiness” sensor indicating whether the headset is actually being worn by a user. The sensor 24 can be implemented using any suitable technology that indicates whether the set is in position on a user's head, including but not limited to thermal sensor or capacitive sensor technology. To eliminate the remote possibility of a user's simply holding rather than wearing a headset, the proximity sensor may employ multiple technologies, such as capacitive sensor technology for indicating skin contact and mercury switch technology for indicating in the headset is oriented and in “upright” position as it is likely be when being worn by the user. As will be discussed in more detail later, the cell phone 18 may include a similar proximity sensor 19.

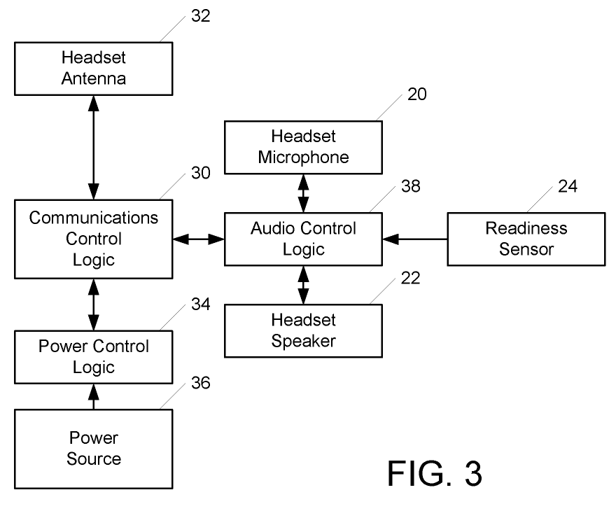

FIG. 3 shows the readiness sensor 24 as one of the functional components of the headset. The headset also includes the headset microphone 20, the headset speaker 22 and the headset antenna 32 that is typically integrated into the body of the earpiece and thus not externally visible. Audio control logic 38 is used to control the operation of the microphone 20 and the speaker 22 and is itself under the control of communications control logic 30, which is at the heart of the headset logical infrastructure. The headset includes a power source 36, which often exists in the form of the rechargeable batteries, and power control logic 34. While the power system elements are shown as being connected only to communications control logic 30, it should be understood that power is typically distributed to all of the components of the headset, not just to communications control logic 30.

For purposes of the present invention, a primary function of the communications control logic 30 is to determine whether the headset is ready for use when the user either makes or receives a telephone call. There are three facets in determining whether the headset is ready for use. The first and most obvious facet is that the headphone is powered up. The second facet is whether the headset has been initialized to exchange audio signals with a base unit (e.g., a cell phone) using a standard communication protocols such as the Bluetooth protocol mentioned earlier. The third facet is whether the headset was actually being worn by a user, which is indicated by control signals provided by the readiness sensor 24.

If the communication control logic 30 determines that the headset is ready for use when a call is made or received, the communications control logic 30 causes the audio control logic 38 to activate the microphone 20 and the speaker 22 in the headset. If it cannot be determined that the headset is ready for use, the microphone 20 and the speaker 22 remain disabled.

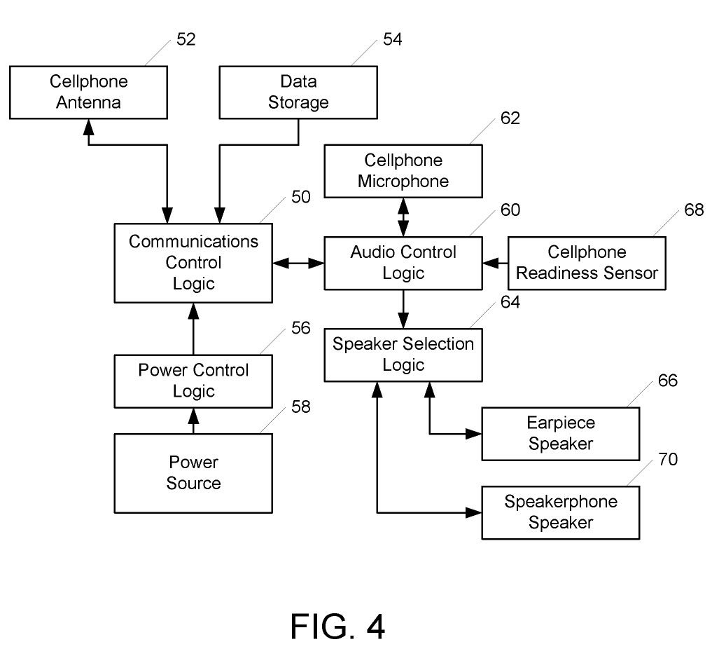

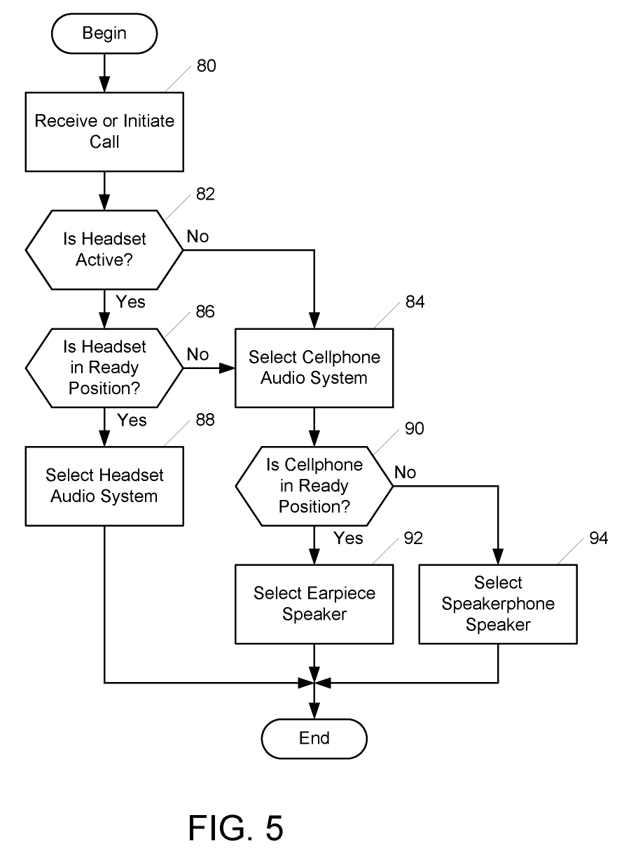

The headset exchanges audio and control signals with base unit logic illustrated in FIG. 4. In the embodiment described thus far, the base unit is assumed to be a telephone and more particularly a cell phone. As will be described later, the base unit does not necessarily have to be a telephone.

A number of the functional components of a cell phone suitable for use with the present invention are similar to the previously described functional components of a headset to be used in conjunction with the cell phone. For example, the cell phone includes a cell phone antenna 52, communications control logic 50, a power source 58, power control logic 56, and audio control logic 60, all of which perform the same general functions as corresponding components in the headset logic system. Unlike the headset, the cell phone includes data storage 54 that can be used to store telephone operating information, contact data, text messages, images, music, video, etc. or any other kind of data contemplated by the designers of the cell phone.

In one embodiment of the invention, the cell phone also includes the readiness sensor 19 previously mentioned with reference to FIG. 1. The sensor 19, which can be implemented using the same kinds of technologies that are used to implement sensor 24 in headset 10, can provide a signal to the audio control logic 60 indicating that the cell phone is being held or otherwise positioned with the cell phone earpiece speaker adjacent to a user's ear. If such a signal is provided, speaker selection logic 64 will activate the cell phone microphone 62 and an earpiece speaker 66 automatically allowing the user to use the cell phone in a conventional hand-on manner. If the signal provided by the cell phone readiness sensor 68 does not indicate that the user has picked up the telephone for conventional hands-on use, the speaker selection logic 64 will cause audio signals to be distributed automatically to a speakerphone speaker 70 in the cell phone to establish an alternative form of hands-free use of the cell phone.

To summarize the above, if the headset logic indicates the headset is initialized and is being worn by the user (that is, is ready for use) when a call is made or received, audio signals are distributed automatically from the base unit to the headset. If the headset logic does not indicate the headset is ready for use, but cell phone logic indicates the user is holding the cell phone with the earpiece speaker adjacent the user's ear, audio signals are distributed to the earpiece speaker in the cell phone. Otherwise, audio signals are distributed to the speakerphone speaker in the cell phone, assuming of course the cell phone has a speakerphone function.

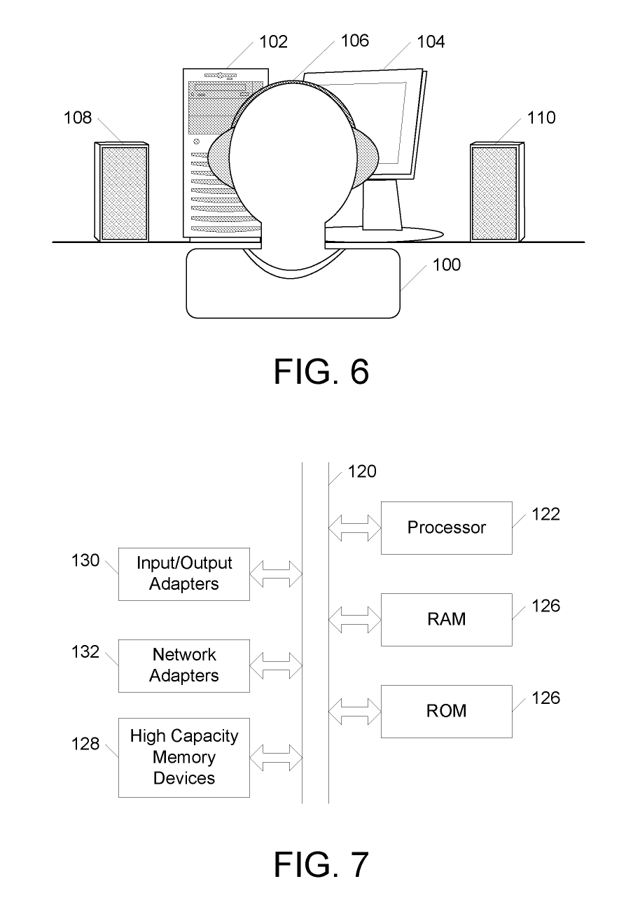

FIG. 6 of the flowchart of basic operations that are performed during use of the described implementation of the present invention. The process begins when a call is received or initiated in an operation 80. A determination 82 is then made as to whether the headset is active. The headset is considered active when it is powered up and has been initialized to exchange signals with a cell phone using a standard communication protocol. If it is determined that the headset is active, a second determination 86 is made as to whether the headset is in a ready position; that is, actually being worn by a user. If the headset is determined to be in the ready position, the headset audio system is selected in an operation 88.

However, if operation 82 fails to establish that the headset is active or operation 86 establishes that the headset is active but is not in a ready position, then a cell phone audio system is selected in an operation 84. Assuming the cell phone is one with speakerphone capability, an operation 90 determines whether the cell phone itself is in a ready position; that is, is being held by the user with the cell phone earpiece speaker adjacent the user's ear. If it can be determined that the cell phone is being held in that position, the earpiece speaker is selected in an operation 92. Otherwise, the speakerphone speaker is selected in an operation 94.

It can be seen from the foregoing that audio signals will be automatically distributed to whichever speaker system a user appears to be ready to use, whether that speaker system is part of a headset, is an earpiece speaker or is a speakerphone speaker, without the user having to consciously select any of the speakers.

While the present invention is most likely to be used by cell phone users having available wireless headsets, the invention may also be useful in other environments. FIG. 6 is an illustration of one such environment. FIG. 6 is intended to show a user of 100 seated at a personal computer system comprising a monitor 104, a system unit 102 and desktop speakers 108 and 110. The personal computer user may opt to use either the desktop speakers 108 and 110 or a headset 106 when listening to music or playing games on the computer. The present invention makes it possible for the user to automatically switch between the headset and the desktop speakers simply by putting the headset on and taking it off provided, of course, the headset is equipped with a readiness sensor indicating the headset is in place on a user's head and the personal computer system includes logic comparable to that previously described with reference to FIG. 4.

Because the present invention will result in audio signals being distributed to a particular speaker system either at the user's ear or at a base unit without user input, it is possible that a user may be momentarily disconcerted when the audio doesn't emanate where the user may have expected it to. To reduce the chances of that happening, audio or visual cues may be used to warn the user which speaker system is being activated. For example, specific tones or chimes may be associated with headset speakers and base unit speakers. Similarly, a cell phone, other telephone or a base unit with a display screen may flash an appropriate message, such as “Headset Speaker On” or “Cell Phone Speaker On” as part of the process of activating the selected speaker system

FIG. 7 is a block diagram of a hardware infrastructure for a general-purpose computer device that could, when programmed properly, be used to implement the present invention in the environment represented by FIG. 6. The infrastructure includes a system bus 130 that carries information and data among a plurality of hardware subsystems including a processor 132 used to execute program instructions received from computer applications running on the hardware. The infrastructure also includes random access memory (RAM) 134 that provides temporary storage for program instructions and data during execution of computer applications and are read only memory (ROM) 136 often used to store program instructions required for proper operation of the device itself, as opposed to execution of computer applications. Long-term storage of programs and data is provided by high-capacity memory devices 138, such as magnetic hard drives or optical CD or DVD drives.

In a typical computer system, a considerable number of input/output devices are connected to the system bus 130 through input/output adapters 140. Commonly used input/output devices include monitors, keyboards, pointing devices and printers. Increasingly, high capacity memory devices are being connected to the system through what might be described as general-purpose input/output adapters, such as USB or FireWire adapters. Finally, the system includes one or more network adapters 142 that are used to connect the system to other computer systems through intervening computer networks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Specifically, terms used in the specification and drawings should be construed broadly. For example, the term “headset” should be construed to include any wearable structure that includes a speaker that positioned on, over, in or near a user's ear when in use. That includes, but is not limited to, over-the-head, behind-the-head, on-the-ear, in-the-ear and hearing aid type structures, regardless whether those structures include a microphone or control buttons in addition to a speaker. As another example, the use of two different terms, earpiece speaker and speakerphone speaker, in referring to speakers in a cell phone does not necessarily imply there are always two physical speakers in the cell phone. The terms should be construed as applying to a single speaker that can be driven to operate in either of two different modes, a conventional hands-on mode or a speakerphone mode. As still another example, the term “base unit” should not be construed as being limited to cell phones, other telephones or personal computers. The term should be construed as including any electronic system that has the capability of providing audio input either through one or more integrated speakers or through a headset, as that term is defined above. A home theatre system that can deliver audio signals either to connected speakers or to a user's headset is just one example of such a base unit.

Having thus described the invention of the present application in detail and by reference to preferred embodiments thereof, it will be apparent that modifications and variations are possible without departing from the scope of the invention defined in the appended claims.

What is claimed is:

1. A method for controlling the distribution of audio signals among audio systems in a headset and in a base unit comprising:
determining whether the headset is ready for use;
in response to a determination that the headset audio system is ready for use, distributing audio signals from the base unit to the headset audio system;
in the absence of a determination that the headset audio system is ready for use, determining whether a base unit audio system is ready for use; and
in response to a determination that the base unit audio system is ready for use, distributing audio signals to the base unit audio system.

2. A method according to claim 1 wherein determining whether the headset is ready for use further comprises determining whether the headset is initialized and is in place on a user's head.

3. A method according to claim 2 wherein the base unit comprises a telephone and the base unit audio system comprises an earpiece speaker in the telephone.

4. A method according to claim 3 wherein determining whether the base unit audio system is ready for use further comprises determining whether the telephone is positioned with the earpiece speaker adjacent to a user's ear.

5. A method according to claim 4 further comprising, in the absence of a determination that the base unit audio system is ready for use, distributing the audio signals to an alternative base unit audio system.

6. A method according to claim 5 wherein the alternative base unit audio system comprises a speakerphone speaker in the telephone.

7. A method according to claim 6 further comprising providing a user-detectable alert indicating which of the audio systems is being selected.

8. An audio control system for controlling the distribution of audio signals among audio systems in a headset and in a base unit comprising:
communications control logic for receiving signals from the headset and for determining whether the received signals indicate the audio headset is ready for use by a user of the base unit;
audio control logic responsive to a determination that the headset is ready for use to distribute audio signals to the headset, said audio control logic being responsive to the absence of a determination that the headset is ready for use to determine whether a base unit audio system is ready for use and, responsive to a determination that the base unit audio system is ready for use, to distribute audio signals to the base unit audio system.

9. An audio control system according to claim 8 wherein said signals indicating the headset is ready for use further comprise signals indicating the headset is initialized and in place on a user's head.

10. An audio control system according to claim 9 wherein the base unit comprises a telephone and the base unit audio system comprises an earpiece speaker in the telephone.

11. An audio control system according to claim 10 wherein said communications control logic is further capable of determining whether the base unit audio system is ready for use and, in the absence of a determination that the base unit audio system is ready for use, of distributing audio signals to a second base unit audio system.

12. An audio control system according to claim 11 wherein said second base unit audio system comprises a speakerphone speaker.

13. An audio control system according to claim 10 further comprising an alert generator for providing a user-detectable alert indicating which of the audio systems is being selected.

14. An audio control system according to claim 12 further comprising an alert generator for providing a user-detectable alert indicating which of the audio systems is being selected.

15. A computer program product for controlling the distribution of audio signals among audio systems in a headset and in a base unit, said computer program product comprising a computer usable medium having computer usable program code embodied therewith, said computer usable program code comprising:
computer usable program code configured to determine whether the headset is ready for use;
computer usable program code configured, in response to a determination that the headset is ready for use, to distribute audio signals to the headset;
computer usable program code configured, in the absence of a determination that the headset is ready for use, to determine whether a base unit audio system is ready for use; and
computer usable program code configured, in response to a determination that the base unit audio system is ready for use, to distribute audio signals to the base unit audio system.

16. A computer program product according to claim 15 wherein the computer usable program code configured to determine whether the headset is ready for use further comprises computer usable program code to determine whether the headset is initialized and is in place on a user's head.

17. A computer program product according to claim 16 wherein the base unit comprises a telephone and the base unit audio system comprises an earpiece speaker in the telephone.

18. A computer program product according to claim 17 wherein said computer usable program code configured to determine whether the base unit audio system is ready for use further comprises computer usable program code for determining whether the telephone is positioned with the earpiece speaker adjacent a user's ear.

19. A computer program product according to claim 18 further comprising computer usable program code configured to, in the absence of a determination that the telephone is positioned with the earpiece speaker adjacent a user's ear, distribute audio signals to an alternative audio system in the telephone, said alternative audio system comprising a speakerphone speaker.

20. A computer program product according to claim 18 further comprising computer usable program code configured to generate a user-detectable alert indicating which of the audio systems is being selected.
